(19) United States
(12) Patent Application Publication
(10) Pub. No.: US 2008/0102720 A1
(43) Pub. Date: May 1, 2008

(54) ABRASIVE ARTICLE AND METHOD OF MAKING AND USING THE SAME

(75) Inventors: William J. Rostal, Maplewood, MN (US); Steven J. Keipert, Somerset, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/554,094

(22) Filed: Oct. 30, 2006

(51) Int. Cl. B32B 5/02

(52) U.S. Cl. 442/59; 442/149; 442/180; 156/60

(57) ABSTRACT

A coated abrasive article having a moisture-insensitive laminate backing comprising woven glass fabric, laminating adhesive, and reinforcing woven fabric. Methods of making and using the coated abrasive article are also included.

### BACKGROUND

Coated abrasive articles (e.g., abrasive discs) typically have a backing with two major opposed surfaces and an abrasive layer secured to a major surface. The abrasive layer generally comprises abrasive particles and at least one binder that secures the abrasive particles to the backing. One common type of coated abrasive article has an abrasive layer comprising a make layer, a size layer, and abrasive particles. In making such a coated abrasive disc, a make layer precursor comprising a first binder precursor is applied to a major surface of the backing. Abrasive particles are then at least partially embedded into the make layer precursor (e.g., via electrostatic coating), and the first binder precursor is typically at least partially cured (i.e., crosslinked) to form a make layer with abrasive particles affixed thereto. A size layer precursor comprising a second binder precursor is then applied over the make layer and abrasive particles, followed by sufficient curing of the size layer precursor (and optional post-curing of the make layer) to give a useful abrasive article. Some coated abrasive discs further comprise a supersize layer covering the abrasive layer. The supersize layer typically includes grinding aids and/or anti-loading materials.

Vulcanized fiber has been widely used as a backing material for heavy duty abrasive discs for more than 60 years, particularly those discs having coarse grades of abrasive grain. The term “vulcanized fiber”, sometimes also referred to as “vulcanised fibre” or “fish paper”, refers to a leather-like material generally formed from cellulose by compressing layers of chemically treated (e.g., as with metallic chlorides) cellulose derived from paper, paper pulp, rayon or cloth. While mechanical properties, availability, and cost of vulcanized fiber make it desirable for use as a backing material in abrasive discs, its hydrophilic nature means that vulcanized fiber is prone to absorb moisture. For example, shape distortion (e.g., curling or cupping) of such abrasive discs may occur due to changes in environmental moisture content (e.g., humidity). Shape distortion may occur, for example, during manufacturing, during storage, or during use. Further, the shape distortion may occur toward and/or away from the abrasive layer. If excessive shape distortion occurs during manufacturing of the coated abrasive article, then it is typically discarded as scrap material. Further, if excessive shape distortion occurs during storage, or in use, it typically results in product complaints, reduced product sales, and/or reduced product performance.

Moisture content of vulcanized fiber abrasive backings may also affect the grinding efficiency of the abrasive article. For example, high fiber moisture content typically softens the backing, reducing support for the abrasive grains and decreasing the peak stock removal rate during use. Mechanical properties of vulcanized fiber such as, for example, tear resistance are also typically affected by variations in moisture content.

Although many backings for abrasive articles have been generically described in the prior art, the continued prevalence of vulcanized fiber in commercially available heavy duty abrasive discs suggests that viable alternatives have not been developed. Thus, there remains a need for alternative moisture-insensitive and dimensionally stable backings for use in the manufacture of coated abrasive articles such as, for example, heavy duty abrasive discs.

### SUMMARY

In one aspect, the present invention provides a coated abrasive article comprising:

a moisture-insensitive laminate backing comprising:
a first fabric layer comprising a woven glass fabric impregnated with a first saturant;
a second fabric layer comprising a first reinforcing woven fabric impregnated with a second saturant; and
a first thermoplastic laminating adhesive that adheres the first and second fabric layers to each other; and

an abrasive layer secured to, and proximate, the first fabric layer, wherein the abrasive layer comprises make and size layers and abrasive particles.

In some embodiments, the first woven glass fabric has a basis weight of from 2 to 20 ounces per square yard (95 to 950 grams per square meter). In some embodiments, the first reinforcing woven fabric has a basis weight of from 2 to 20 ounces per square yard (95 to 950 grams per square meter). In some embodiments, the first reinforcing woven fabric comprises a polyester fabric. In some embodiments, the first reinforcing woven fabric comprises a second woven glass fabric. In some embodiments, the moisture-insensitive laminate backing has a thickness of from 10 to 100 mils (0.25 to 2.5 mm).

In some embodiments, at least one of the first or second saturants comprises an at least partially crosslinked phenolic resin, aminoplast resin, epoxy resin, or combination thereof.

In some embodiments, the first laminating adhesive comprises a polyamide.

In some embodiments, the moisture-insensitive laminate backing further comprises:
a third fabric layer comprising a second reinforcing woven fabric impregnated with a third saturant; and
a second thermoplastic laminating adhesive that adheres the second and third fabric layers to each other.

In some embodiments, the coated abrasive article further comprises a supersize layer proximate the size layer.

In some embodiments, the coated abrasive article comprises a coated abrasive disc.

Coated abrasive articles according to the present invention are useful for abrading a workpiece. For example, one useful method comprises: providing a coated abrasive article according to the present invention; frictionally contacting at least a portion of the abrasive layer with at least a portion of a surface of the workpiece; and moving at least one of the abrasive layer or the workpiece relative to the other to abrade at least a portion of the surface.

In another aspect, the present invention provides a method of making a coated abrasive article, the method comprising:

providing a moisture-insensitive laminate backing comprising:
a first fabric layer comprising a woven glass fabric impregnated with a first saturant;
a second fabric layer comprising a first reinforcing woven fabric impregnated with a second saturant; and
a first thermoplastic laminating adhesive that adheres the first and second fabric layers to each other; and

applying a curable make layer precursor on at least a portion of the moisture-insensitive laminate backing proximate the first fabric layer;

applying abrasive particles to the coated curable make resin;

at least partially curing the curable make layer precursor to provide a make layer;

applying a curable size layer precursor on at least a portion of the make layer and abrasive particles; and

at least partially curing the curable size layer precursor to provide a size layer.

In some embodiments, the moisture-insensitive laminate backing further comprises:
a third fabric layer comprising a second reinforcing woven fabric impregnated with a third saturant; and
a second thermoplastic laminating adhesive that adheres the second and third fabric layers to each other.

In some embodiments, the coated abrasive article comprises a coated abrasive disc.

As used herein:

the adjective “moisture-insensitive” in reference to a backing means that the physical properties and dimensions of the backing are substantially unaffected by variations in ambient humidity;

the adjective “thermoplastic” means having the property of softening or fusing when heated and of hardening and becoming rigid again when cooled (thermoplastic materials can typically be re-melted and cooled time after time without undergoing appreciable chemical change); and

the adjective “thermosetting” means having the property of becoming permanently hardened (e.g., by a chemical crosslinking reaction) when heated or otherwise cured.

### BRIEF DESCRIPTION OF THE DRAWING

FIG. 1 is a cross-sectional schematic drawing of an exemplary coated abrasive article according to one embodiment of the present invention; and

FIG. 2 is a perspective schematic drawing of an exemplary coated abrasive disc according to one embodiment of the present invention.

### DETAILED DESCRIPTION

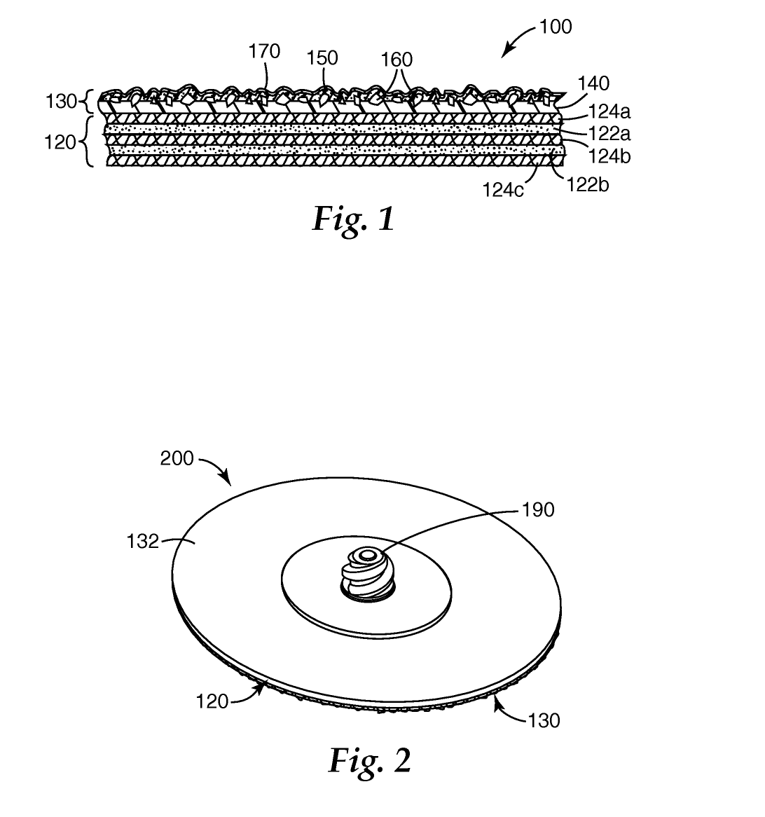

Referring now to FIG. 1, exemplary coated abrasive article 100 comprises abrasive layer 130 secured to moisture-insensitive laminate backing 120. Laminate backing 120 comprises first fabric layer 124a, which is in turn adhered by first thermoplastic laminating adhesive 122a to second fabric layer 124b. Abrasive layer 130 is secured to, and proximate, first fabric layer 124a. Abrasive layer 130 comprises make and size layers 140, 150, respectively, and abrasive particles 160. Optional supersize 170 is disposed on size layer 150. Moisture-insensitive laminated backing 120 may, optionally, further comprise third fabric layer 124c, which is adhered to second fabric layer 124b by second thermoplastic laminating adhesive 122b.

First fabric layer 124a comprises a woven glass fabric impregnated with a first saturant. Second fabric layer 124b comprises a first reinforcing fabric impregnated with a second saturant. Optional third fabric layer 124c comprises a second reinforcing fabric impregnated with a third saturant. The moisture-insensitive laminate backing may, optionally, have additional fabric layer(s) adhered to the optional third fabric layer by laminating adhesive(s).

The moisture-insensitive laminate backing typically has a thickness in a range of from 10 to 100 mils (0.25 to 2.5 mm); for example, from 10 to 50 mils (0.25 to 1.3 mm), or even from 20 to 40 mils (0.51 to 1.0 mm), although thicknesses outside this range may also be used, for example, if desired for a particular application. The weave orientation of the fabric layers may have any orientation; however, it may be desirable to bias the orientation of the warp grain of the fabric layers to provide a more isotropic laminate backing.

The first fabric layer comprises a woven glass fabric impregnated with a first saturant. Typically, the woven glass fabric has a basis weight of from 2 to 20 ounces per square yard (95 to 950 grams per square meter), for example, a basis weight of from 4 to 15 ounces per square yard (30 to 710 grams per square meter), or even a basis weight of from 5 to 13 ounces per square yard (240 to 360 grams per square meter); however, other basis weights may be used. Typically, the first saturant is added to the glass fabric at an add-on weight of from 1 to 50 percent based on the untreated fabric weight); for example, from 10 to 30 percent based on the untreated fabric weight, or even 15 to 25 percent based on the untreated fabric weight, although other amounts of saturant may also be used.

The second and optional third fabric layers comprise reinforcing woven fabrics that may be the same as, or different from, each other and/or other fabric layers. For example, in some embodiments, the second and/or third reinforcing fabrics may comprise a woven glass fabric (e.g., as used in the first fabric layer). In other embodiments, the second and/or third reinforcing fabrics may comprise a non-glass woven fabric. Examples of such woven fabrics include fabrics made from synthetic fibers (e.g., polyester, polyamide, polyimide, and combinations thereof) and/or natural fibers (e.g., cotton, hemp, or jute). Woven fabrics comprising glass fibers and synthetic and/or natural fibers may also be used.

Typically, the reinforcing woven fabrics have a basis weight in a range of basis weight of from 2 to 20 ounces per square yard (95 to 950 grams per square meter), for example, a basis weight of from 4 to 15 ounces per square yard (30 to 710 grams per square meter) or even a basis weight of from 5 to 13 ounces per square yard (240 to 360 grams per square meter); however, other basis weights may be used.

Useful saturants include thermosetting resins such as, e.g., phenolic resins, aminoplast resins, epoxy resins, and combinations thereof. Generally, the saturants are applied to the woven fabrics in a substantially fluid state (optionally in a solvent), which is then thermoset (i.e., at least partially crosslinked) by application of energy (e.g., heat). Typically, the second saturant is added to the glass fabric (e.g., glass fabric or reinforcing fabric) at an add-on weight of from 1 to 100 percent based on the untreated fabric weight); for example, from 10 to 50 percent based on the untreated fabric weight, or even 15 to 40 percent based on the untreated fabric weight, although other amounts of saturant may also be used.

To improve wetting and adhesion of the saturants to the fabrics, the fabrics may incorporate surface treatments such as, for example, silane treatments. Wetting agents and surfactants may also be incorporated into the saturating resins.

Examples of useful thermoplastic laminating adhesives include polyamides (e.g., nylon-6 and nylon-6,6), polyimides, poly(vinyl chloride), poly(vinyl acetate), polyesters, thermoplastic polyurethanes, polyolefins (e.g., polyethylene, polypropylene, polybutylene, polybutadiene), polyacetals, polycarbonates, thermoplastic acrylic resins, natural and synthetic rubbers, and combinations thereof. The laminating adhesive may be conveniently used as a film having a thickness of from 1 to 10 mils (0.025 to 0.25 mm); for example, from 2 to 8 mils (0.051 to 0.20 mm), or even from 3-6 mils (0.076 to 0.15 mm), although other thickness may also be used. Further, the laminating adhesive may be supplied in other forms such as, for example, a molten fluid. Typically, the laminating adhesive(s) is/are bonded to the various fabric layers (e.g., first fabric layer, second fabric layer, etc.) using sufficient heat and/or pressure to ensure a strong adhesive bond.

Various properties of the laminated backing may be advantageously adjusted to provide desirable working attributes. For example, the moisture-insensitive laminate backing should generally have sufficient breaking strength to prevent rotational failure (e.g., at least 300 pounds per inch width (53.6 kg per cm width), and more typically in a range of from 800 to 2000 pounds per inch width (53.6 to 357 kg per cm width)), although this is not a requirement. Similarly, the laminate backing should typically have a Young's modulus of at least 500,000 pounds per square inch (3500 MPa) (e.g., in a range of from 500,000 to 20,000,000 pounds per square inch (3500 to 138000 MPa)), although this is not a requirement. In addition, to facilitate operator handling the flex modulus of the laminated backing may be selected to be in a range of from 35 to 500 megapascals (MPa), more typically in a range of from 175 to 475 MPa. To help prevent snagging and breaking, the impact resistance of the laminated backing may be at least 0.1 joule (e.g., in a range of from 0.3 to 1 joule).

To promote adhesion of binder resins to the backing, one or more surfaces of the laminated backing (e.g., an exposed surface of the first fabric layer) may be modified by known methods including corona discharge, ultraviolet light exposure, electron beam exposure, flame discharge, and/or scuffing.

The laminated backing may optional have one or more treatments thereon such as, for example, a subsize, a presize, a backsize, a tie layer, or a combination thereof.

The make and size layers may comprise any binder resin that is suitable for use in abrading applications. Many useful binder resins are known and include phenolic binders, acrylic binders, epoxy binders, isocyanurate binders, urea-formaldehyde binders, aminoplast binders, and combinations thereof. The binder resins are generally prepared by at least partially curing (i.e., crosslinking) a corresponding binder precursor; for example, free-radically polymerizable monomer and/or oligomers, epoxy resins, phenolic resins, aminoplast resins, urea-formaldehyde resins, isocyanurate resins, and combinations thereof.

The make and size layers may include other conventional components in combination with the binder such as, for example, coupling agents, fibers, lubricants, plasticizers, suspending agents, wetting agents, fillers, surfactants, grinding aids, dyes, and pigments.

Typically, the make layer is prepared by coating at least a portion of the backing (treated or untreated) with a make layer precursor. Abrasive particles are then at least partially embedded (e.g., by electrostatic coating) in the make layer precursor comprising a first binder precursor, and the make layer precursor is at least partially polymerized. Next, the size layer is prepared by coating at least a portion of the make layer and abrasive particles with a size layer precursor comprising a second binder precursor (which may be the same as, or different from, the first binder precursor), and at least partially curing the size layer precursor. In one embodiment, the make layer precursor may be partially polymerized prior to coating with abrasive particles and further polymerized at a later point in the manufacturing process.

Useful abrasive particles are well known in the abrasive art and include for example, fused aluminum oxide, heat treated aluminum oxide, semi-friable aluminum oxide, white fused aluminum oxide, black silicon carbide, green silicon carbide, titanium diboride, boron carbide, tungsten carbide, titanium carbide, diamond, cubic boron nitride, garnet, fused alumina zirconia, sol gel abrasive particles, silica, iron oxide, chromia, ceria, zirconia, titania, silicates, metal carbonates (such as calcium carbonate (e.g., chalk, calcite, marl, travertine, marble and limestone), calcium magnesium carbonate, sodium carbonate, magnesium carbonate), silica (e.g., quartz, glass beads, glass bubbles and glass fibers) silicates (e.g., talc, clays, (montmorillonite) feldspar, mica, calcium silicate, calcium metasilicate, sodium aluminosilicate, sodium silicate) metal sulfates (e.g., calcium sulfate, barium sulfate, sodium sulfate, aluminum sodium sulfate, aluminum sulfate), gypsum, aluminum trihydrate, graphite, metal oxides (e.g., tin oxide, calcium oxide), aluminum oxide, titanium dioxide) and metal sulfites (e.g., calcium sulfite), metal particles (e.g., tin, lead, copper), plastic abrasive particles formed from a thermoplastic material (e.g., polycarbonate, polyetherimide, polyester, polyethylene, polysulfone, polystyrene, acrylonitrile-butadiene-styrene block copolymer, polypropylene, acetal polymers, polyvinyl chloride, polyurethanes, nylon), plastic abrasive particles formed from crosslinked polymers (e.g., phenolic resins, aminoplast resins, urethane resins, epoxy resins, acrylate resins, acrylated isocyanurate resins, urea-formaldehyde resins, isocyanurate resins, acrylated urethane resins, acrylated epoxy resins), and combinations thereof.

The abrasive particles may have any size (e.g., in a size range of from 0.1 to 5000 micrometers) and may correspond to industry recognized grades such as, for example, ANSI (American National Standard Institute), FEPA (Federation of European Producers of Abrasives), or JIS (Japanese Industrial Standard). Examples of ANSI grade designations include: ANSI 4, ANSI 6, ANSI 8, ANSI 16, ANSI 24, ANSI 36, ANSI 40, ANSI 50, ANSI 60, ANSI 80, ANSI 100, ANSI 120, ANSI 150, ANSI 180, ANSI 220, ANSI 240, ANSI 280, ANSI 320, ANSI 360, ANSI 400, and ANSI 600. Examples of FEPA grade designations include P8, P12, P16, P24, P36, P40, P50, P60, P80, P100, P120, P150, P180, P220, P320, P400, P500, P600, P800, P1000, and P1200. Examples of JIS grade designations include JIS8, JIS12, JIS16, JIS24, JIS36, JIS46, JIS54, JIS60, JIS80, JIS100, JIS150, JIS180, JIS220, JIS240, JIS280, JIS320, JIS360, JIS400, JIS400, JIS600, JIS800, JIS1000, JIS1500, JIS2500, JIS4000, JIS6000, JIS8000, and JIS10000.

In one method of making coated abrasive articles according to the present invention, a curable make layer precursor is applied to the moisture-insensitive laminate backing proximate the first fabric layer. The basis weight of the make layer precursor utilized may depend, for example, on the intended use(s), type(s) of abrasive particles, and nature of the coated abrasive article being prepared, but generally will be in the range of from 1, 2, or 5 to 20, 25, 400, or even 600 grams per square meter (i.e., g/m²). The make layer precursor may be applied by any known coating method for applying a make layer precursor to a backing, including, for example, roll coating, extrusion die coating, curtain coating, knife coating, gravure coating, and spray coating.

After applying the make layer precursor to the backing, and prior to solidification of the make layer precursor (e.g., by curing), abrasive particles are deposited onto the make layer precursor. Coating weights for the abrasive particles may depend, for example, on the specific coated abrasive article desired, the process for applying the abrasive particles, and the size of the abrasive particles, but typically range from 1 to 2000 g/m².

Next, the curable make layer precursor is at least partially cured to provide a make layer. Curing may be accomplished by any suitable means (e.g., heat, microwave radiation, ultraviolet and/or visible radiation, electron beam), typically depending on the choice of make layer precursor).

A curable size layer precursor is applied onto at least a portion of the make layer and abrasive particles, and at least partially cured to provide a size layer. Curing may be accomplished by any suitable means (e.g., heat, microwave radiation, ultraviolet and/or visible radiation, electron beam), typically depending on the choice of size layer precursor). The basis weight of the size layer precursor will typically vary depending on the intended use(s), type(s) of abrasive particles, and nature of the coated abrasive article being prepared, but generally will be in the range of from 1 or 5 g/m² to 300, or even 800 g/m², or more. The size layer may be applied by any known coating method for applying a size layer to a backing including, for example, roll coating, extrusion die coating, curtain coating, and spray coating.

Optionally, a supersize may be applied to at least a portion of the size layer. The supersize may include one or more optional components in combination with the binder such as, for example, coupling agents, fibers, lubricants, plasticizers, suspending agents, wetting agents, fillers, surfactants, grinding aids, dyes, and pigments.

Details concerning coated abrasive articles comprising abrasive particles and make, size, and optional supersize layers are well known and are described, for example, in U.S. Pat. No. 5,436,063 (Follett et al.); U.S. Pat. No. 5,961,674 (Gagliardi et al.); U.S. Pat. No. 4,751,138 (Tumey et al.); U.S. Pat. No. 5,766,277 (DcVoc et al.); U.S. Pat. No. 6,077,601 (DcVoc et al.); U.S. Pat. No. 6,228,133 (Thurber et al.); and U.S. Pat. No. 5,975,988 (Christianson), the disclosures of which are incorporated herein by reference.

Abrasive articles according to the present invention are useful for abrading a workpiece in a process wherein at least a portion of the abrasive layer of a coated abrasive article is frictionally contacted with the abrasive layer with at least a portion of a surface of the workpiece, and then at least one of the coated abrasive article or the workpiece is moved relative to the other to abrade at least a portion of the surface. The abrading process may be carried out, for example, by hand or by machine. Optionally, liquid (e.g., water, oil) and/or surfactant(s) (e.g., anionic surfactant and/or nonionic surfactant) may be applied to the workpiece, for example, to facilitate the abrading process.

Coated abrasive articles according to the present invention are useful, for example, as coated abrasive discs. Referring now to FIG. 2, exemplary coated abrasive disc 200 comprises moisture-insensitive laminated backing 120 having abrasive layer 130 secured thereto. Threaded post 190 is secured to major surface 132 of laminated backing 120 opposite abrasive layer 130.

Objects and advantages of this invention are further illustrated by the following non-limiting examples, but the particular materials and amounts thereof recited in these examples, as well as other conditions and, details, should not be construed to unduly limit this invention. Unless otherwise noted, all parts, percentages, ratios, etc. in the examples and the rest of the specification are on a weight basis.

### EXAMPLES

Table 1 (below) lists abbreviations used in the Examples.

TABLE 1

| ABBREVIATION | DESCRIPTION |
|---|---|
| AP1 | ceramic aluminum oxide abrasive particles, grade 50, obtained |
| | under the trade designation “CUBITRON” from 3M Company, |
| | Saint Paul, Minnesota |
| AP2 | ceramic aluminum oxide abrasive particles, grade 36, obtained |
| | under the trade designation “CUBITRON” from 3M Company. |
| CACO1 | calcium carbonate, obtained under the trade designation |
| | “HUBERCARB Q4” from Huber Engineered Materials, |
| | Atlanta, Georgia |
| CACO2 | calcium carbonate, obtained under the trade designation |
| | “HUBERCARB Q6” from Huber Engineered Materials |
| CRY | filler, obtained under the trade designation “CRYOLITE |
| | TYPE RTN-C” from Koppers Trading, Pittsburgh, |
| | Pennsylvania |
| GF1 | phenolic resin impregnated woven glass fabric, “STYLE 64”, |
| | 8.72 oz/sq yd (0.294 kg/m²), plain weave, 18 × 18 count, |
| | obtained from Industrial Polymers and Chemicals Inc., |
| | Shrewsbury, Massachusetts |
| GF2 | untreated woven glass fabric, “STYLE 3732”, 14.23 oz/sq yd |
| | (0.480 kg/m²), satin weave, 48 × 32 count, obtained from BGF |
| | Industries, Inc., Greensboro, North Carolina |
| GF3 | GF2 treated with PR2 at 20 percent dry add-on weight |
| IO | iron oxide pigment |
| LA | laminating hot melt adhesive film, 3 mil “4220 NYLON”, 116° C. |
| | softening temperature, obtained from Bemis Company Inc., |
| | Shirley, Massachusetts |
| PF | polyester fabric, “YF”, obtained from Milliken Corporation, |
| | Spartanburg, South Carolina, saturated with 5.5 grams of PR2 |
| | per 7-inch (18-cm) disc and dried 3 minutes at 100° C. |
| PR1 | phenolic resin, “0361 SW”, obtained from Hexion Specialty |
| | Chemicals Inc., Columbus, Ohio |
| PR2 | 75% aqueous solution of phenol-formaldehyde resin having a |
| | phenol to formaldehyde ratio of 1.5–2.1:1, catalyzed with 2.5 |
| | percent potassium hydroxide |
| WA | wetting agent “EMULON A”, obtained from BASF Corp., Mt. |
| | Olive, New Jersey |
| Backing 1 | vulcanized fiber web, 0.83 mm (33 mil) thick, obtained under |
| | the trade designation “DYNOS Vulcanized Fibre” from |
| | DYNOS GmbH, Troisdorf, Germany |
| Backing 2 | woven glass fabric laminated backing consisting of two layers |
| | of GF1 bonded by 1 layer of LA via a Hix Corp. “N-800” |
| | press set at 250° F. (121° C.) and 40 psi (0.28 MPa) for 30 |
| | seconds |
| Backing 3 | Laminated backing consisting of one layer of GF1 laminated |
| | to 1 layer of PF with LA under same conditions as Backing 2. |
| | The abrasive coating applied to the GF1 side of the backing |
| Backing 4 | one layer of GF1 with LA adhered to it |
| Backing 5 | same as Backing 3, except that the abrasive coating was |
| | applied to the PF side |
| Backing 6 | woven glass fabric laminated backing consisting of two layers |
| | of GF3 bonded by one layer of LA using a Hix Corp. “N-800” |
| | press set at 250° F. (121° C.) and 40 psi (0.28 MPa) for 30 |
| | seconds |
| Backing 7 | woven glass fabric laminated backing consisting of three |
| | layers of GF3 bonded by 2 layers of LA using a Hix Corp. “N- |
| | 800” press set at 250° F. (121° C.) and 40 psi (0.28 MPa) for 30 |
| | seconds |
| Backing 8 | glass/polyester fabric laminated backing consisting of 3 layers. |
| | One layer of GF3 was bonded to each side of PF by 2 layers of |
| | LA using a Hix Corp. “N-800” press set at 250° F. (121° C.) and |
| | 40 psi (0.28 MPa) for 30 seconds |

### Make and Size Layer Precursors

The compositions of the make and size layer precursor precursors for the various Examples are reported in Table 2 (below).

TABLE 2

| | MAKE | |
|---|---|---|
| | LAYER PRECURSOR, | SIZE LAYER PRECURSOR, |
| COMPONENT | parts by weight | parts by weight |
| PR1 | 500.1 | 0 |
| PR2 | 0 | 447 |
| Water | 55.2 | 250 |
| WA | 1.1 | 0 |
| CACO1 | 250 | 0 |
| CACO2 | 250 | 0 |
| CRY | 0 | 699 |
| IO | 0 | 25 |

In Examples 1 to 12 and Comparative Examples A to F (below), after coating the make layer precursor on the backing and application of the abrasive particles, the make layer precursor was heated for 3 hrs at 95° C. After coating the size layer precursor on the make layer and abrasive particles, the size layer precursor was heated for 12 hrs at 95° C. The resultant coated abrasive articles were further heated for 24 hrs at 100° C.

### Examples 1-5 and Comparative Examples A-C

Abrasive discs, 7-inch diameter×⅞-inch center hole (18 cm diameter×2.2 cm center hole), cut from Examples 1-5 and Comparative Examples A-C were prepared using amounts and ingredients as reported in Table 3 (below).

TABLE 3

| | | ADD-ON WEIGHT PER DISC, | | |
|---|---|---|---|---|
| | | grams | | |
| | | MAKE | | SIZE |
| | | LAYER | | LAYER |
| | BACKING | PRECURSOR | AP1 | PRECURSOR |
| COMPARATIVE | BACKING 1 | 3.6 | 12.0 | 10.8 |
| EXAMPLE A | | | | |
| COMPARATIVE | BACKING 1 | 3.6 | 12.5 | 10.6 |
| EXAMPLE B | | | | |
| EXAMPLE 1 | BACKING 2 | 6.5 | 12.1 | 9.0 |
| EXAMPLE 2 | BACKING 2 | 5.1 | 11.3 | 9.2 |
| EXAMPLE 3 | BACKING 3 | 10.8 | 11.6 | 10.3 |
| EXAMPLE 4 | BACKING 3 | 9.4 | 11.4 | 10.3 |
| COMPARATIVE | BACKING 4 | 5.2 | 11.4 | 9.0 |
| EXAMPLE C | | | | |
| EXAMPLE 5 | BACKING 5 | 5.6 | 11.6 | 9.0 |

### Hydraulic Slide Action Test

This test, designed to measure the cut rate of the coated abrasive discs, was used to compare the abrading efficacy of the abrasive discs cut from Examples 1, 3, and 5 and Comparative Examples A and C. The abrasive discs, 7-inch diameter×⅞-inch center hole (18 cm diameter×2.2 cm center hole) discs, were used to grind the face of a 1.25 cm by 18 cm 1018 mild steel workpiece. The grinder used was a constant load hydraulic disc grinder. A constant load between each workpiece and abrasive disc was maintained at 7.26 kg (16 pounds) force. The back-up pad for the grinder was an aluminum back-up pad. The disc was secured to the aluminum pad by a retaining nut and was driven at 5,000 rpm. During operation, the test disc was tilted (“heeled”) at approximately 7 degrees to present an abrasive band extending from the edge and in towards the center 3.5 cm to the workpiece. During testing, the workpiece was traversed along its length at a rate of about 8.4 cm per second. Each disc was used to grind a separate workpiece for successive 60-second intervals. Cut was determined for additional 60-second grinding intervals until an endpoint was reached. The endpoint (indicated by “-”) was determined when consecutive cycles produced 40 grams of cut or less for two consecutive cycles or when the disc integrity was compromised. The test results are reported in Table 4 (below).

TABLE 4

| | Cut, grams | | | | | | | |
|---|---|---|---|---|---|---|---|---|
| TIME, | COMPARATIVE | COMPARATIVE | COMPARATIVE | EXAMPLE | EXAMPLE | EXAMPLE | EXAMPLE | |
| minutes | EXAMPLE A | EXAMPLE B | EXAMPLE C | 1 | 2 | 3 | 4 | EXAMPLE 5 |
| 1 | 81.9 | 78.4 | 77.8 | 83.5 | 84 | 80.6 | 86.1 | 77.9 |
| 2 | 89.9 | 79.6 | 83.5 | 88.1 | 86.4 | 90.3 | 89 | 82.7 |
| 3 | 94.4 | 87.8 | 82.1 | 91.9 | 89.9 | 92 | 93.2 | 88.8 |
| 4 | 101.8 | 94.7 | 84.6 | 96.4 | 95.2 | 94.2 | 98.3 | 92.3 |
| 5 | 100.5 | 99.9 | 84.9 | 98.4 | 100.2 | 100.4 | 98.6 | 90.3 |
| 6 | 101.7 | 102.1 | 85.3 | 95.2 | 100.2 | 99.2 | 95.2 | 99.4 |
| 7 | 100.3 | 101.9 | 62 | 100.9 | 93.9 | 103.4 | 98.7 | 97.7 |
| 8 | 101.1 | 104.8 | — | 101 | 99 | 100.3 | 95.1 | 97.4 |
| 9 | 102.7 | 103.8 | — | 101.5 | 100.7 | 98.7 | 98.3 | 95.8 |
| 10 | 102.2 | 104.3 | — | 97.7 | 98.7 | 96.7 | 98.3 | 96.6 |
| 11 | 99.3 | 104.5 | — | 103.3 | 95.9 | 91 | 95.8 | 94.1 |
| 12 | 100.2 | 101.3 | — | 102.3 | 96.4 | 91.7 | 98.2 | 90.6 |
| 13 | 99.5 | 102.3 | — | 100.3 | 94.1 | 88.2 | 97 | 88.7 |
| 14 | 95.2 | 99 | — | 92.7 | 87.2 | 87.3 | 94.8 | 90.1 |
| 15 | 90.7 | 99.1 | — | 95.3 | 88.1 | 85.2 | 92.1 | 88.3 |
| 16 | 85.9 | 87.5 | — | 81.3 | 81.3 | 78.4 | 83.8 | 79.5 |
| 17 | 88.4 | 93.5 | — | 87.6 | 87.7 | 82.8 | 87.4 | 83.3 |
| 18 | 89.6 | 90.3 | — | 89.5 | 90.7 | 81.4 | 86.2 | 84.1 |
| 19 | 89.2 | 87.4 | — | 88.1 | 89.4 | 81.2 | 87.3 | 85.9 |
| 20 | 82.6 | 84.9 | — | 88.3 | 89 | 81.5 | 85.4 | 81.6 |
| 21 | 84.4 | 83.9 | — | 89.3 | 85.7 | 82.1 | 84.7 | 78.8 |
| 22 | 82.3 | 77.8 | — | 85.5 | 84.3 | 81 | 86.2 | 77 |
| 23 | 80.7 | 76 | — | 85.4 | 83.2 | 77.2 | 85.1 | 75.3 |
| 24 | 77.6 | 68.7 | — | 81.7 | 81.7 | 77.1 | 84.1 | 71.6 |
| 25 | 74.6 | 65.1 | — | 82 | 82.3 | 74 | 80.8 | 70.1 |
| 26 | 71.4 | 62.5 | — | 80.4 | 79 | 71.8 | 77.6 | 68.2 |
| 27 | 69.2 | 60.1 | — | 75.9 | 75.5 | 70.1 | 77 | 65.7 |
| 28 | 65.1 | 55.1 | — | 73.4 | 74.7 | 67.4 | 73.4 | 61.7 |
| 29 | 61 | 52.4 | — | 74.3 | 73.5 | 65.6 | 73.3 | 60 |
| 30 | 58.2 | 49 | — | 70 | 72.1 | 63.1 | 73 | 57 |
| 31 | 55.3 | 44.1 | — | 65.7 | 69 | 61.8 | 71.8 | 54.5 |
| 32 | 50.4 | — | — | 64 | 66.5 | 62.3 | 68.6 | 52 |
| 33 | 45.6 | — | — | 63.6 | 62.7 | 60 | 69.2 | 48.6 |
| 34 | 43.1 | — | — | 60.8 | 60.2 | 57.7 | 65.2 | 45.2 |
| 35 | — | — | — | 58.7 | 59.5 | 53.9 | 60.6 | 43.2 |
| 36 | — | — | — | 53.7 | 56.6 | 48.9 | 61.7 | 41.5 |
| 37 | — | — | — | 49 | 54.9 | 46 | 58.8 | — |
| 38 | — | — | — | 47.3 | 52.3 | 43 | 56.3 | — |
| 39 | — | — | — | 44.9 | 51 | 40.9 | 51.9 | — |
| 40 | — | — | — | 41.5 | 48.3 | — | 49.5 | — |
| 41 | — | — | — | — | 46.6 | — | 48.7 | — |
| 42 | — | — | — | — | 44.7 | — | 46.2 | — |
| 43 | — | — | — | — | 42.2 | — | 44.7 | — |
| 44 | — | — | — | — | — | — | 41.6 | — |
| 45 | — | — | — | — | — | — | 40.2 | — |
| CUMULATIVE | 2816 | 2593.8 | 560.2 | 3230.4 | 3354.5 | 3008.4 | 3489 | 2755.5 |
| CUT | | | | | | | | |

### Examples 6-8 and Comparative Examples D-F

Abrasive discs, 7-inch diameter×⅞-inch center hole (18 cm diameter×2.2 cm center hole), cut from Examples 6-8 and Comparative Examples D-F were prepared using amounts and ingredients as reported in Table 5 (below), wherein Comparative Example E was a commercially available disc obtained from 3M Company, St. Paul, Minn., under the trade designation “988C GRADE 36”.

TABLE 5

| | | ADD-ON WEIGHT | | |
|---|---|---|---|---|
| | | PER DISC, grams | | |
| | | MAKE | | SIZE |
| | | LAYER | | LAYER |
| | BACKING | PRECURSOR | AP2 | PRECURSOR |
| EXAMPLE 6 | BACKING 6 | 7 | 17.7 | 17.3 |
| EXAMPLE 7 | BACKING 2 | 6.4 | 22.1 | 19.5 |
| COMPARATIVE | BACKING 1 | 5.2 | 20.9 | 17.2 |
| EXAMPLE D | | | | |
| COMPARATIVE | BACKING 1 | 4.4 | 18.3 | 12.5 |
| EXAMPLE E | | | | |
| COMPARATIVE | BACKING 1 | 4.2 | 19.5 | 18.6 |
| EXAMPLE F | | | | |
| EXAMPLE 8 | BACKING 2 | 6.2 | 23.1 | 18.4 |

### Shape Stability

Abrasive discs were tested to determine their susceptibility to dimensional changes due to environmental conditions. Out-of-plane distortion was measured after discs were subjected to either dry conditions (Oven Test) or humid conditions (80% Test).

For the Oven Test, the initial, ambient, out-of-plane distortion of 7-inch diameter×⅞-inch center hole (18 cm diameter×2.2 cm center hole) discs was measured by placing each disc on a horizontal surface with any obvious concavity facing the horizontal surface. The distortion was quantified by measuring the height of the center hole above the horizontal surface. Negative values indicate that the abrasive side was concave. Positive values indicate that the backing side was concave. Test discs were then placed in a forced convection oven set at 60° C. (140° F.) for 4 hours. The test discs were removed from the oven and the out-of-plane distortion measured again.

The 80% Test was identical to the Oven Test, with the exception that the environmental challenge was subjecting the test discs to an 80% Relative Humidity and 23° C. environment for 67 hours in an environmental test chamber (Model No. SE-1000-6-6 environmental test chamber available from Thermotron Industries, Holland, Mich.) instead of the oven.

Results from Shape Stability tests are reported in Table 6 (below), wherein the data for the Comparative Examples show variable shape changes in each test depending on the initial (ambient) moisture content of the disc.

TABLE 6

| | | INITIAL | | |
|---|---|---|---|---|
| | | DISTOR- | FINAL | |
| | TEST | TION, | DISTORTION, | CHANGE, |
| | METHOD | mm | mm | mm |
| EXAMPLE 6 | Oven Test | 3.5 | 3.2 | −0.3 |
| EXAMPLE 7 | Oven Test | 5.5 | 5.0 | −0.5 |
| COMPARATIVE | Oven Test | 2.2 | 5.0 | 2.8 |
| EXAMPLE D | | | | |
| COMPARATIVE | Oven Test | 6.0 | 38.0 | 32.0 |
| EXAMPLE E | | | | |
| COMPARATIVE | 80% | 1.5 | −28 | −29.5 |
| EXAMPLE F | | | | |
| EXAMPLE 8 | 80% | 5.0 | 6.0 | 1 |

### Examples 9-11 and Comparative Example G

Examples 9-11 and Comparative Example G show the effects of additional fabric layers for the abrasive article backing. In these examples, the compositions of the make and size layer precursors were as reported in Table 2, except that the WA was omitted from the make layer precursor, and the size layer precursor was diluted 2:1 with water to reduce the viscosity to enable application by spraying instead of roll coating. Additionally, abrasive particles AP2 were used instead of AP1, as reported in Table 7 (below), wherein wet add-ons are reported as averages for each Example.

TABLE 7

| | | WET ADD-ON | | |
|---|---|---|---|---|
| | | WEIGHT PER | | |
| | | DISC, grams | | |
| | | MAKE | | SIZE |
| | BACKING | COAT | AP2 | COAT |
| COMPARATIVE | BACKING 1 | 3.7 | 17.9 | 16 |
| EXAMPLE G | | | | |
| EXAMPLE 9 | BACKING 6 | 5.6 | 17.8 | 16 |
| EXAMPLE 10 | BACKING 7 | 5.6 | 18 | 16 |
| EXAMPLE 11 | BACKING 8 | 5.9 | 17.9 | 16 |

Abrasive articles of Examples 9-11 and Comparative Example G were tested according to the Hydraulic Slide Action Test as described hereinabove, except that the load between the discs and workpieces was changed to 8.62 kg (19 pounds), and the endpoint (indicated by “-” in Table 8) was determined by a consecutive cycle cut difference of 70 grams or when the disc integrity was compromised. Hydraulic Slide Action Test results are reported in Table 8 (below).

TABLE 8

| | CUT, grams | | | | | | | | | | | |
|---|---|---|---|---|---|---|---|---|---|---|---|---|
| REPLICATE | COMPARATTVE | | | | | | | | | | | |
| TIME, | EXAMPLE G | | | EXAMPLE 9 | | | EXAMPLE 10 | | | EXAMPLE 11 | | |
| minutes | 1 | 2 | 3 | 1 | 2 | 3 | 1 | 2 | 3 | 1 | 2 | 3 |
| 1 | 121.1 | 126.3 | 125.2 | 130.6 | 129.7 | 122.8 | 135.6 | 120.3 | 126.3 | 130 | 136.3 | 135 |
| 2 | 142 | 148.9 | 138.8 | 154 | 151.5 | 147.8 | 159.4 | 148.1 | 153.6 | 141.1 | 159.6 | 156.7 |
| 3 | 152.6 | 156 | 147.4 | 166.2 | 164 | 150.4 | 167 | 164.8 | 160.4 | 152.6 | 166.6 | 164.8 |
| 4 | 148.3 | 153.3 | 150.9 | 162 | 161.7 | 151.8 | 164.3 | 161 | 150.1 | 163.3 | 161 | 160.5 |
| 5 | 136.3 | 145.5 | 148.8 | 149.2 | 153.3 | 141 | 148.6 | 162.3 | 149 | 162.2 | 158.1 | 163.3 |
| 6 | 124.2 | 134.1 | 106.5 | 134.7 | 140.4 | 119 | 141.9 | 148.2 | 138.8 | 152.3 | 145.3 | 153.2 |
| 7 | 90.2 | 124.9 | 90 | 122.7 | 124.5 | 102.4 | 131.3 | 140.4 | 138.5 | 143.4 | 128.8 | 136.6 |
| 8 | 73.2 | 109.1 | — | 112 | 102.6 | 87.1 | 125.4 | 130.1 | 120.7 | 130.4 | 111.3 | 126 |
| 9 | — | 90.8 | — | 100.4 | 83.7 | 73.1 | 118.3 | 111 | 100.2 | 115.3 | 97.5 | 112.3 |
| 10 | — | 84.3 | — | 74.8 | 72.5 | — | 107.4 | 95.1 | 81.8 | 96.1 | 79.4 | 95.7 |
| 11 | — | — | — | — | — | — | 88.6 | 82.4 | — | 85.5 | — | 86.4 |
| | — | — | — | — | — | — | — | — | — | 72.9 | — | 79.5 |
| CUMULATIVE | 987.9 | 1273.2 | 907.6 | 1306.6 | 1283.9 | 1095.4 | 1487.8 | 1463.7 | 1319.4 | 1545.1 | 1343.9 | 1570.0 |
| CUT | | | | | | | | | | | | |

### Examples 12-13 and Comparative Examples H-J

### Humidity Effect on Cut

Abrasive discs from Examples 12-13 and Comparative Examples H-J were tested for the effect of moisture level on their cut performance. The discs were conditioned under either wet or dry conditions, and their cut performance was evaluated using the Hydraulic Slide Action test, with a 7.26 kilogram (16 pound) load as described hereinabove. The dry conditioning consisted of a 16 hour bake at 130° F. (54° C.). The wet conditioning consisted of 20 hours in an 86 percent relative humidity chamber. Discs were tested within 2 hours of being conditioned. The compositions of the discs and their conditioning treatments are reported in Table 9 (below).

TABLE 9

| | | ADD-ON | | | |
|---|---|---|---|---|---|
| | | WEIGHT PER | | | |
| | | DISC, grams | | | CONDI- |
| | | MAKE | | SIZE | TIONING |
| | BACKING | COAT | AP1 | COAT | TREATMENT |
| COMPAR- | BACKING 1 | 3.3 | 13.4 | 9.6 | WET |
| ATIVE | | | | | |
| EXAMPLE H | | | | | |
| COMPAR- | BACKING 1 | 3.3 | 13.1 | 9.6 | DRY |
| ATIVE | | | | | |
| EXAMPLE I | | | | | |
| EXAMPLE 12 | BACKING 2 | 4.8 | 10.4 | 9.6 | WET |
| EXAMPLE 13 | BACKING 2 | 4.8 | 10.4 | 9.6 | DRY |

Hydraulic Slide Action test results for Examples 12-13 and Comparative Examples H-J are reported in Table 10 (below).

TABLE 10

| | CUT, grams | | | |
|---|---|---|---|---|
| | COMPAR- | | EXAM- | EXAM- |
| | ATIVE | COMPARATIVE | PLE | PLE |
| TIME, minutes | EXAMPLE H | EXAMPLE I | 12 | 13 |
| 1 | 104.5 | 109.4 | 120.5 | 119.0 |
| 2 | 96.3 | 127.6 | 134.0 | 140.2 |
| 3 | 102.2 | 127.4 | 133.0 | 140.7 |
| 4 | 103.3 | 121.4 | 126.7 | 133.8 |
| 5 | 93.3 | 109.3 | 109.4 | 125.6 |
| 6 | 83.8 | 95.4 | 88.3 | 115.3 |
| 7 | 72.2 | 77.6 | 77.1 | 105.4 |
| 8 | 56.8 | 64.8 | 57.7 | 94.4 |
| 9 | 43.6 | 49.0 | 34.9 | 87.2 |
| 10 | — | 38.1 | — | 73.5 |
| 11 | — | — | — | 58.7 |
| 12 | — | — | — | 48.5 |
| 13 | — | — | — | 40.6 |
| CUMULATIVE | 756 | 920 | 881.6 | 1282.9 |
| CUT | | | | |

Various modifications and alterations of this invention may be made by those skilled in the art without departing from the scope and spirit of this invention, and it should be understood that this invention is not to be unduly limited to the illustrative embodiments set forth herein.

What is claimed is:

1. A coated abrasive article comprising:
a moisture-insensitive laminate backing comprising:
a first fabric layer comprising a woven glass fabric impregnated with an at least partially crosslinked first saturant;
a second fabric layer comprising a first reinforcing woven fabric impregnated with an at least partially crosslinked second saturant; and
a first thermoplastic laminating adhesive that adheres the first and second fabric layers to each other; and
an abrasive layer secured to, and proximate, the first fabric layer, wherein the abrasive layer comprises make and size layers and abrasive particles.

2. The coated abrasive article of claim 1, wherein the first woven glass fabric has a basis weight of from 2 to 20 ounces per square yard.

3. The coated abrasive article of claim 1, wherein the first reinforcing woven fabric comprises a polyester fabric.

4. The coated abrasive article of claim 1, wherein the first reinforcing woven fabric comprises a second woven glass fabric.

5. The coated abrasive article of claim 1, wherein the first reinforcing woven fabric has a basis weight of from 2 to 20 ounces per square yard.

6. The coated abrasive article of claim 1, wherein the moisture-insensitive laminate backing has a thickness of from 10 to 100 mils.

7. The coated abrasive article of claim 1, wherein at least one of the first or second saturants comprises an at least partially crosslinked phenolic resin, aminoplast resin, epoxy resin, or combination thereof.

8. The coated abrasive article of claim 1, wherein the first laminating adhesive comprises a polyamide.

9. The coated abrasive article of claim 1, wherein the moisture-insensitive laminate backing further comprises:
a third fabric layer comprising a second reinforcing woven fabric impregnated with a third saturant; and
a second thermoplastic laminating adhesive that adheres the second and third fabric layers to each other.

10. The coated abrasive article of claim 1, further comprising a supersize layer proximate the size layer.

11. The coated abrasive article of claim 1, wherein the coated abrasive article comprises a coated abrasive disc.

12. A method of abrading a workpiece, the method comprising:
providing a coated abrasive article according to claim 1;
frictionally contacting at least a portion of the abrasive layer with at least a portion of a surface of the workpiece; and
moving at least one of the abrasive layer or the workpiece relative to the other to abrade at least a portion of the surface.

13. A method of making a coated abrasive article, the method comprising:
providing a moisture-insensitive laminate backing comprising:
a first fabric layer comprising a woven glass fabric impregnated with a first saturant;
a second fabric layer comprising a first reinforcing woven fabric impregnated with a second saturant; and
a first thermoplastic laminating adhesive that adheres the first and second fabric layers to each other; and
applying a curable make layer precursor on at least a portion of the moisture-insensitive laminate backing proximate the first fabric layer;
applying abrasive particles to the coated curable make resin;
at least partially curing the curable make layer precursor to provide a make layer;
applying a curable size layer precursor on at least a portion of the make layer and abrasive particles; and
at least partially curing the curable size layer precursor to provide a size layer.

14. The method of claim 13, wherein the first woven glass fabric has a basis weight of from 2 to 20 ounces per square yard.

15. The method of claim 13, wherein the first reinforcing woven fabric comprises a polyester fabric.

16. The method of claim 13, wherein the first reinforcing woven fabric comprises a second woven glass fabric.

17. The method of claim 13, wherein at least one of the first or second saturants comprises an at least partially crosslinked phenolic resin, aminoplast resin, epoxy resin, or combination thereof.

18. The method of claim 13, wherein the first laminating adhesive comprises a polyamide.

19. The method of claim 13, wherein the moisture-insensitive laminated backing further comprises:
a third fabric layer comprising a second reinforcing woven fabric impregnated with a third saturant; and
a second thermoplastic laminating adhesive that adheres the second and third fabric layers to each other.

20. The method of claim 13, wherein the coated abrasive article comprises a coated abrasive disc.
